(19) United States
(12) Patent Application Publication
(10) Pub. No.: US 2005/0077995 A1
(43) Pub. Date: Apr. 14, 2005

(54) UNIVERSAL KEY SECURITY METHOD AND SYSTEM

(75) Inventors: Craig A. Paulsen, Reno, NV (US); Binh T. Nguyen, Reno, NV (US)

Correspondence Address: BEYER WEAVER & THOMAS LLP, P.O. BOX 70250, OAKLAND, CA, 94612-0250, US

(73) Assignee: IGT, Reno, NV (US)

(21) Appl. No.: 10/605,574

(22) Filed: Oct. 9, 2003

(51) Int. Cl. G06K 19/00

(52) U.S. Cl. 340/5.6; 340/5.73; 463/29

(57) ABSTRACT

A method and apparatus for providing universal key security in a mechanical key access environment is disclosed. An electromechanical lock is provided for securing an environment, whereby access is permitted through the steps of receiving a key in the lock, reading a first source of indicia from the key, wherein said first source of indicia comprises information or data specific to said lock, reading a second source of indicia, wherein the second source of indicia comprises information specific to the user of the key, and authorizing a use of the key based on both indicia readings. One embodiment involves the use of a biometric device within the key or on or near the lock, with one example of such a device being a fingerprint sensor. Another embodiment involves the use of added information, such as the entry of an individual PIN number by the user of the key.

### BACKGROUND OF INVENTION

### TECHNICAL FIELD

The present invention relates generally to a method and apparatus for providing security, and more specifically to a method and apparatus for providing key secured access to a device such as a gaming machine.

response to modern technological advances and varying needs to protect property, combat crime, and prevent unwanted or unauthorized intrusions, increasingly sophisticated locks and locking devices are now common in many homes and businesses, such as banks, department stores, jewelry stores, shopping malls, schools, casinos and other gaming establishments. Such locks and locking devices can prevent unwanted access to a wide variety of areas and devices, especially when used in conjunction with additional security measures. While secured access may be desired with respect to persons or things physically entering a given location, such as a building or room, secured access may also may also be desirable with respect to accessing the contents of various devices such as, for example, safes, lockboxes, lockers, display cabinets, file cabinets, electronic or computer equipment, and an assortment of different secured devices. In some instances, such a secured device may have numerous secured regions with varied levels of security and corresponding requirements for accessing each region. One example of such a multi-level secured device could be a gaming machine (i.e., slot machine).

Because casinos and other forms of gaming comprise a growing multi-billion dollar industry wherein large sums of money can quickly change hands during many types of fast paced games, casinos and other gaming establishments are a prime target for cheating and stealing, and thus a prime candidate for more innovative and complex security devices and systems, which can include newer locks and locking devices. Because casinos and other gaming establishments in particular frequently utilize sophisticated security devices and techniques, casinos and gaming machines in general comprise an ideal illustrative example for the types of locking devices, and in particular the universal key security methods and systems, disclosed herein. Accordingly, the following discussion and illustrative examples are directed primarily to casino and gaming machine security devices and systems as a matter of convenience, although it should be borne in mind that such security systems and devices are readily applicable to other types of establishments, venues and items.

There are a variety of devices associated with a gaming machine that can require varying levels of security. Examples of devices for which security measures can be separate and independent include bill acceptors, coin drops or hoppers, a game EEPROM or Central Processing Unit (“CPU”), and communication boards, among others. Many such devices are built into the gaming machine, although it is possible for one or more to exist outside of the machine itself. Traditionally, security has been provided with respect to a main door of a gaming machine by means of an ordinary mechanical key and lock apparatus. Additional internal devices within a gaming machine, such as those listed above, are also frequently secured with an identical or similar ordinary mechanical key and lock apparatus. Apparatuses and methods for providing keyed access to an area or device, such as for gaming machines within a casino, are generally well known, and instances of such apparatuses and methods can be found in, for example, U.S. Pat. Nos. 4,677,834; 6,125,673 and 6,604,394, all of which are incorporated herein by reference in their entirety and for all purposes.

It has also become popular of late for many gaming establishments to add an additional access feature whereby keyed access to a gaming machine or gaming machine component is preferably accompanied by use of an identifying card, such as an employee tracking card. Such a card is read upon access to the machine, such that employee information and other transactional details can be noted and/or tracked locally or remotely. Use of such a card is mostly an informational tool, however, such that access to a gaming machine and any of its internal compartments can still be had so long as the person seeking access has the appropriate mechanical key or keys. Use of such a card is also disadvantageous in that it introduces an additional step into the secured access process, which can be cumbersome and inconvenient.

Regardless of whether a card is used, unauthorized access to a gaming machine may be possible for an experienced thief in some cases. Such access can also be rather easy where a key or set of keys falls into the wrong hands. While key theft, use of a lost key or unauthorized key duplication are some examples of keys falling into the wrong hands, other instances include occasions where casino personnel having some level of security access are terminated or otherwise leave their position and do not return their keys, as is typically required. Although costly, it is not unheard of for entire banks or floors of gaming machines to be refitted with new locks where a particular set of keys is lost or stolen, or where a group of machines has been targeted repeatedly by those having improper access to one or more keys.

Accordingly, there exists a need for improved methods and systems for providing secured access to an area or device via mechanical keys and locks, and in particular for such methods and systems to eliminate the need for a tracking card while providing better ways of ensuring against unauthorized access to a gaming machine, despite the presence of a correct mechanical key for that machine.

### SUMMARY OF INVENTION

It is an advantage of the present invention to provide a method and apparatus for universal key security such that a higher level of security can be had with respect to a secured environment or object. According to one embodiment of the present invention, the provided method and apparatus involve the use of one or more specially designed locks and/or keys in a gaming machine, whereby unauthorized access to the gaming machine is curtailed despite the presence of a correct key for that particular machine. This is accomplished by designing the lock such that one or more additional criteria in addition to a physical key are needed in order to open the lock. Such additional criteria can include the use of biometric information or a PIN number for an authorized user, or other factors beyond the shape of a designated key.

In one particular embodiment, a mechanical key is utilized in conjunction with an electromechanical lock, wherein the lock requires both insertion and operation of the mechanical key and a separate authorizing electrical signal in order to open. This separate electrical signal can be the result of a correct reading of a biometric parameter for an authorized user, such as a fingerprint. In one instance, the fingerprint of an authorized user can be read and approved by a device built into the mechanical key itself, whereupon a positive authorizing signal can be sent to the electromechanical lock to permit access. Alternatively, the fingerprint can merely be sensed by such a device within the key, with the data being sent to an approval mechanism either inside the gaming machine itself or at some remote location, whereupon a positive authorizing signal can be relayed to the lock if the user of the key is an authorized individual.

According to another embodiment of the present invention, the provided method and apparatus involve the use of one or more alternative personal identifiers in addition to a mechanical key. Such personal identifiers can include a numerical keypad requiring the use of a Personal Identification Number or PIN, wherein the numerical keypad can be on or near the device or item to be accessed, or on the key itself. In this manner, a mechanical key can be designed to contain one or more indicia that reflect upon the particular lock to be opened, such as the particular key shape and profile for correctly manipulating the mechanical pins or levers within the lock, as well as one or more indicia that reflect upon the particular authorized user, such as a fingerprint.

Other methods, features and advantages of the invention will be or will become apparent to one with skill in the art upon examination of the following figures and detailed description. It is intended that all such additional methods, features and advantages be included within this description, be within the scope of the invention, and be protected by the accompanying claims.

### BRIEF DESCRIPTION OF DRAWINGS

The included drawings are for illustrative purposes and serve only to provide examples of possible structures and process steps for the disclosed inventive universal key security method and apparatus. These drawings in no way limit any changes in form and detail that may be made to the invention by one skilled in the art without departing from the spirit and scope of the invention.

FIG. 1 illustrates in perspective view an exemplary gaming machine according to one embodiment of the present invention.

FIG. 2 illustrates in perspective view the gaming machine of FIG. 1 having an opened main door according to one embodiment of the present invention.

FIG. 3 illustrates in side perspective view an exemplary electromechanical lock according to one embodiment of the present invention.

FIG. 4 illustrates in side elevation view an exemplary mechanical key having an embedded biometric device according to one embodiment of the present invention.

FIG. 5 illustrates in magnified side elevation view the electrical contacts of the mechanical key of FIG. 4 according to one embodiment of the present invention.

FIG. 6 illustrates in side perspective view an alternative exemplary electromechanical lock according to one embodiment of the present invention.

FIG. 7 illustrates in side elevation view an alternative exemplary mechanical key having an embedded biometric device according to one embodiment of the present invention.

FIG. 8 illustrates a block diagram of a particular “non-system controlled” universal key security reading system according to one embodiment of the present invention.

FIG. 9 illustrates a block diagram of an alternative “system controlled” key security reading system according to another embodiment of the present invention.

FIG. 10 illustrates a block diagram of a particular network infrastructure for providing a universal key security method and system according to one embodiment of the present invention.

FIG. 11 illustrates an exemplary database containing associated data identifiers of various authorized and canceled individuals according to one embodiment of the present invention.

FIG. 12 illustrates a flowchart of one method of providing a universal key security method and system according to one embodiment of the present invention.

### DETAILED DESCRIPTION

An example application of a method and system according to the present invention is described in this section. This example is being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following example should not be taken as definitive or limiting either in scope or setting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

One advantage of the present invention is the provision of a method and apparatus for universal key security such that a higher level of security can be had with respect to a secured environment or object. In one embodiment, one or more specially designed locks and/or keys are provided, whereby unauthorized access to an area or device is curtailed despite the presence of a correct key for that particular area or device. This is accomplished by designing a lock such that one or more additional criteria in addition to a physical key are needed in order to open the lock. Such additional criteria can include the use of biometric information or a PIN number for an authorized user, or other factors beyond the shape of a designated key.

As discussed previously, while the inventive universal key security method and system disclosed herein is being described primarily with references to and illustrations of gaming establishments and gaming machines, this system is readily adaptable for use in other types of businesses and environments, such that its use is not restricted exclusively to gaming machines or within a gaming establishment. Continuing now with the illustrative example of a universal key security method and system within a casino or other gaming establishment, it is common knowledge that such establishments are prime targets for thieves, cheats and other assorted criminal actors both on the outside and “inside.”

In particular, slot machines and other gaming machines are a favored mark for many types of attempted thefts and cheats for a variety of reasons. Thus, gaming machines are particularly pertinent devices for illustrating the functions and capabilities of the inventive method and system disclosed herein.

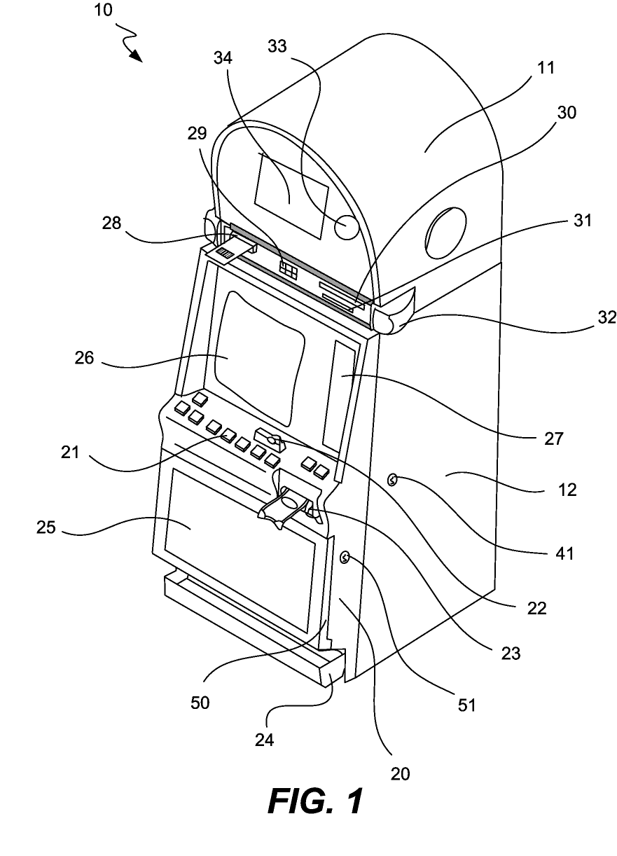

Turning now to FIG. 1, an exemplary gaming machine according to one embodiment of the present invention is illustrated in perspective view. Gaming machine 10 includes a top box 11 and a main cabinet 12, which generally surrounds the machine interior (not shown) and is viewable by users. Main cabinet 12 includes a main door 20 on the front of the machine, which opens to provide access to the interior of the machine. Attached to the main door are typically one or more player-input switches or buttons 21, one or more money or credit acceptors, such as a coin acceptor 22, and a bill or ticket validator 23, a coin tray 24, and a belly glass 25. Viewable through main door 20 is a primary video display monitor 26 and one or more information panels 27. The primary video display monitor 26 will typically be a cathode ray tube, high resolution flat-panel LCD, plasma/LED display or other conventional electronically controlled video monitor. Top box 11, which typically rests atop of the main cabinet 12, may also contain a ticket printer 28, a key pad 29, one or more additional displays 30, a card reader 31, one or more speakers 32, one or more cameras 33, and a secondary video display monitor 34, which may also be a cathode ray tube, high resolution flat-panel LCD, plasma/LED display or other conventional electronically controlled video monitor. Other components and combinations are also possible, as is the ability of the top box to contain one or more traditionally reserved for main cabinet locations, and vice versa.

Gaming machine 10 also includes one or more locking devices designed to restrict access into the gaming machine. Such devices can comprise mechanical or electromechanical locks requiring the use of one or more keys, with preferably at least one lock being key accessible at some location on the outside of the machine. Such locks can include, for example, warded, bit, barrel, cylinder, pin tumbler, wafer tumbler, wafer side bar, tubular, vending and utility style locks, as well as any other style lock, as desired. Similarly, such keys can include, for example, bit, barrel, flat, tubular, cylinder and tubular style keys, as well as any other style key, as desired. As illustrated in FIG. 1, a main door lock comprises at least one key access on the outside surface of the machine, such as, for example, key access 41, through which a key can be used to unlock and open main door 20. In addition, one or more internal machine components may be directly accessible from the outside of the machine, with one example being of such access being external belly door 50, which comprises a lock also having a key access 51 on the outside surface of the machine. Although not shown, additional machine components may also be directly accessible from the outside of the machine in a similar manner. Alternatively, one or more internal machine components may require more than one level of access, with one example being the need to unlock and open main door 20 before unlocking and accessing an internal machine component.

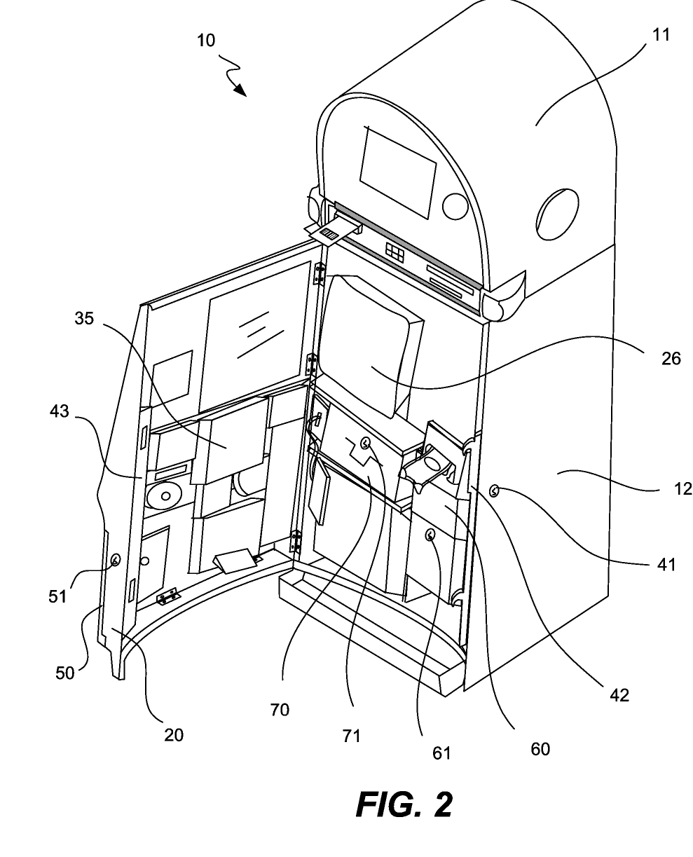

With reference to FIG. 2, the gaming machine of FIG. 1 having an opened main door is illustrated in perspective view. In additional to the exterior items described above, such as top box 11, main cabinet 12 and primary video display monitor 26, gaming machine 10 also comprises a variety of internal components. Such components include, for example, a coin acceptor 35, main door locking mechanisms 42 and 43, the reverse side of belly door 50, and a number of other items not listed here as a matter of convenience. Main door locking mechanisms 42 and 43 comprise a standard hooked bar and receptacle slot mechanical locking system, wherein hooked bar 42 is actuated up and down to lock or unlock main door 20 through a successful operation of key access 41. Although this particular mechanical locking system has been introduced for purposes of illustration, it will be understood that any other standard locking system is interchangeable with that which is illustrated, as other such locking systems will also suffice to achieve the objects and purposes of the inventive universal key security methods disclosed herein.

As seen in FIG. 2, a number of additional secured areas having locks with key accesses for same are also included within the internal regions of gaming machine 10. For example, internal bill acceptor 60 comprises a locked bill storage area having key access 61. Similarly, a secured electronics region 70 comprises a locked box for holding the machine CPU and/or other critical electronic components, with the lock having key access 71. Other internal components not shown, such as a coin drop, coin hopper or electronic communications board, for example, can also be similarly secured. In this manner, not only must one open the main door 20 of the gaming machine, but one must also overcome additional security means or measures to access one or more of these internal regions, with each internal region preferably having different access requirements than the main door and every other internal region respectively. Alternatively, as stated above, one or more internal components may be directly accessible without the need for opening main door 20. One such example involves the access of internal bill acceptor 60, which can be accomplished through the opening of external belly door 50 via key access 51 and internal bill acceptor 60 via key access 61 while the main door remains closed.

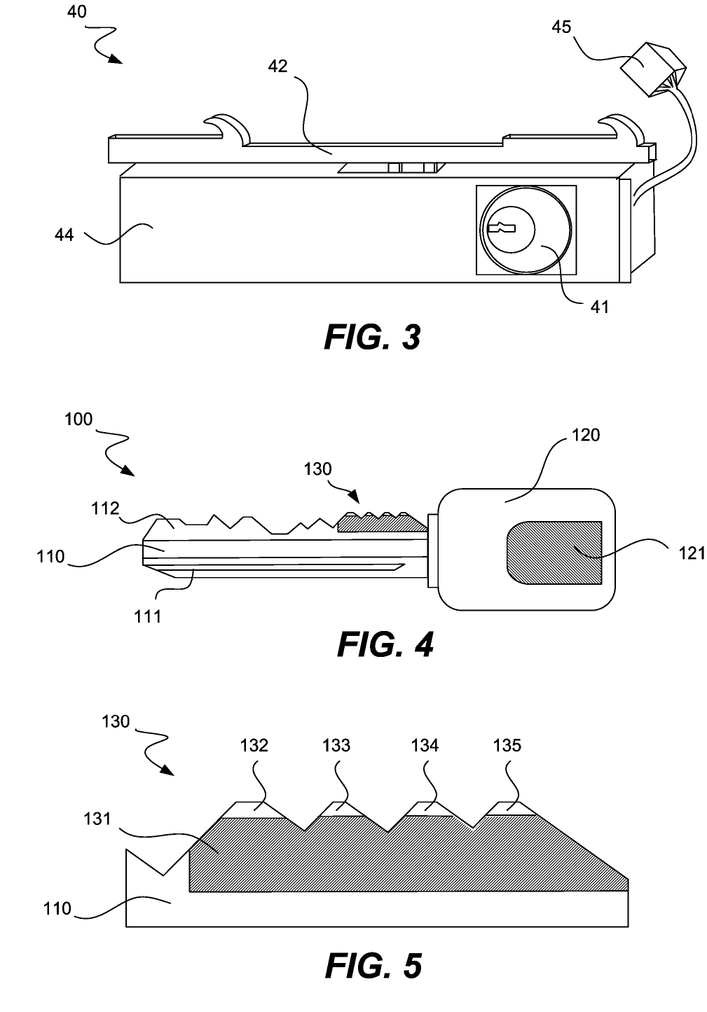

Turning now to FIG. 3, an exemplary electromechanical lock according to one embodiment of the present invention is illustrated in side perspective view. Electromechanical lock 40 comprises a cylinder style mechanical lock having a key access 41, one or more associated locking mechanisms 42, an external housing 44 and one or more electrical connections 45. As set forth above, favorable control and movement of locking mechanism 42 is accomplished as a result of a successful operation of the lock, preferably via key access 41 through use of an authorized key by an authorized user. In a preferred embodiment, lock 40 cannot be successfully operated without both the use of an appropriate mechanical key and the inclusion of an authorizing electrical signal in the lock. This authorizing electrical signal can be sent into the lock from an outside source via connection 45, or can be generated entirely from within the lock, key access, and/or key itself. Alternatively, any type of wireless communications, such as a wireless fidelity (“Wi-Fi”) type example of a Bluetooth® Wireless system utilizing an IEEE 802.1x or other similar standard networking technology, can be utilized to transmit the authorizing signal. In the event that both a mechanical key and authorizing electrical signal are present, one or more solenoids or other actuating devices within the electromechanical lock are then activated such that locking mechanism 42 can be favorably manipulated.

Such a favorable condition of having both a correct key and an authorizing electrical signal may result in the ability of key access 41 being rotatable, whereupon rotation of the key within the key access will then control the locking mechanism. Alternatively, lock 40 can be designed such that an appropriate mechanical key can always be rotated within the key access, except that the appropriate solenoid or other actuating mechanism within the lock will not actually be activated without an appropriate authorizing electrical signal being present. Methods and apparatuses for using solenoids or other actuating mechanisms within an electromechanical lock are well known in the art, and it is specifically contemplated that any such appropriate method or apparatus can be used in conjunction with the inventive universal key security methods and systems disclosed herein.

One example of an advanced electromechanical lock and system usable in conjunction with gaming machines, and in particular with the present invention, is described in commonly assigned and co-pending U.S. patent application Ser. No. 09/824,621, by Mattice, et al. filed on Apr. 2, 2001, and entitled “Method and Apparatus for Controlling Access to Areas of Gaming Machines,” which application is incorporated herein in its entirety and for all purposes. Another exemplary use of a mechanical key and other information in conjunction with gaming machines and systems is described in commonly assigned U.S. Pat. No. 6,439,996, which issued to LeMay, et al. on Aug. 27, 2002, and is entitled “Key for a Gaming Machine and Method of Use Thereof,” which patent is also incorporated herein in its entirety and for all purposes. As discussed herein, use of the disclosed electromechanical lock and system is preferably accomplished within a gaming machine or system through the use of user specific data or information, such as biometric information. Another example of biometric information being used in conjunction with gaming machines and systems is described in commonly assigned and co-pending U.S. patent application Ser. No. 09/491,899, by Wells, et al. filed on Jan. 27, 2000, and entitled “Gaming Terminal and System with Biometric Identification,” which application is also incorporated herein in its entirety and for all purposes.

Referring now to FIG. 4, an exemplary mechanical key having an embedded biometric device according to one embodiment of the present invention is illustrated in side elevation view. Mechanical key 100 comprises a cylinder key having a profiled component 110 and a handle 120. Profiled component 110 is preferably constructed from a hard metal or plastic, such that its shape and profile will be substantially maintained over time. For purposes of discussion herein, it will be assumed that this component is made out of metal, and in particular steel, although a variety of other suitable materials are possible and are also contemplated. This metal region of the key includes one or more indicia that can be “read” by a lock to determine whether or not the key is a correct key for that lock. Such indicia can include a number of characteristics such as a groove arrangement, a side profile, one or more edge profiles and/or the overall physical shape of the key.

Specific key shape 111, which is essentially a combination of the side profile and groove arrangement for the profiled component 110, is commonly used in many types of metal keys. This side profile and groove arrangement essentially permit the key to be physically received into certain types of locks, including the type for which the key is intended, while blocking it from being received into most other types of locks. The side profile can include a variety of grooves formed along the side of profiled component 111, as well as any number of wholesale twists and turns, frequently between 3 and 7. Each groove and each profile twist or turn can function as a separate index for distinguishing key 100 from many other keys. Accordingly, specific shape or side profile 111 is one source of indicia comprising information or data specific to a lock whereby key 100 can be read. Profiled or metal component 110 also includes at least one and sometimes two edge profiles 112, which are used to manipulate pins and/or levers within the lock tumbler or other internal lock structure. Each rise, fall, tooth, valley and plateau along an edge profile can function as a separate index for key 100, such that edge profile 112 is another source of indicia comprising information specific to a lock whereby key 100 can be read. If key 100 is indeed the correct key for a given lock, then its specific shape 111 will allow it to fit the lock, while its edge profile 112 will push all the necessary pins and/or levers within the lock into their correct positions for access, such that the lock “reads” the key as being correct, as will be readily understood by those skilled in the art.

Key handle 120 can be constructed from the same material as the rest of the key, but is preferably made of a plastic, resin or other hardened and electrically insulating material. According to one embodiment of the present invention, handle 120 includes at least one biometric device 121, which is preferably embedded within the handle, and is preferably a fingerprint sensor. Such a fingerprint sensor can be an MBF300 Fingerprint Sweepsensor™ manufactured by Fujitsu, Ltd. of Tokyo, Japan, or either of the EntrePad AES3400 or AES2500 Fingerprint Sensors manufactured by AuthenTec, Inc. of Melbourne, Fla., for example, although other brands and types of fingerprint sensors can be effectively utilized as well. This fingerprint sensor is preferably designed to sense one or more critical portions of a fingerprint, such that a decision can be made on whether or not a user of the key is an authorized user. Techniques for the electronic reading, analysis and determination of fingerprints are well known in the art, and any such technique is contemplated as being usable in conjunction with the present invention. Accordingly, a fingerprint or other form of biometric data is one source of indicia comprising information or data specific to a particular user of key 100.

A decision on whether a sensed fingerprint is indeed authorized can be made in any number of ways, such as through a smart chip or other processor within the fingerprint sensor itself or embedded elsewhere on the key handle, or by a remote processor to which the fingerprint sensor communicates information regarding the fingerprint being sensed. Such a remote analysis and decision may be desirable for a number of reasons. For example, the expense involved in inserting a microprocessor into a key handle can be considerable, and may tend to result in a more fragile key. In addition, the ability of a cheat or thief to defraud a system may be enhanced where a key processed signal design permits the intercepting and/or mimicking of an appropriate authorization signal emanating from the key itself. Conversely, a design that has only a fingerprint sensor on the key with the analysis and authorization being done remotely is likely to have more safeguards against tampering and fraud. In any event, one or more electrical signals are preferably sent and/or received from key 100 as a way of communicating data and/or authorization status with respect to the fingerprint sensed at the key handle, and such electrical signals can be communicated through an electrical contact region 130 of the key, a Wi-Fi type or other wireless system or other communication means, as desired. In addition, any communicated data and/or authorization signal or status is preferably encrypted through any of a number of readily available encryption programs or systems.

Although the foregoing illustrative example has been made with respect to the biometric example of a fingerprint, it will be readily understood that other forms of biometric information can be used in place of or in conjunction with a fingerprint. Examples of such additional biometric features include facial features, for which facial recognition programs are available, vocal tones and features, for which voice recognition programs are available, and retinal features, for which retinal scan devices are available. Any one of these or a variety of other biometric indicators can be used in conjunction with the provided universal key security method and system to result in an application whereby some particular biometric feature of an authorized key user is stored and utilized to compare to a subsequently read biometric feature of an attempted key user to verify whether the attempted key user is legitimate.

Alternatively, a non-biometric informational source can be utilized to provide indicia specific to one or more authorized key users. Such a non-biometric informational source can comprise, for example, a numerical, alphabetical and/or symbolic manual keypad adapted to accept a Personal Identification Number (“PIN”) or similar access code. In one embodiment, such a keypad can comprise an ordinary 10-key numerical keypad, wherein the PIN for an individual can be any numerical code having a convenient series of numbers, preferably from four to ten digits in length, although both shorter and longer lengths of digits are also contemplated. Preferably, an authorized PIN is known only to a particular user or a restricted group of users, such that entry of an authorized PIN appropriately reflects indicia that are specific to one or more authorized key users. An operable keypad can be miniaturized and built onto the mechanical key itself or, alternatively, can be installed at a location at or near the electromechanical lock to be opened. Such a location may be on the object to be accessed, such as a gaming machine, or on some other readily accessible nearby device, wall or other structure. Readers for other indicia, such as a fingerprint sensor, voice detection system or retinal scanner can also be similarly located at or near the electromechanical lock to be opened.

Another item that can be used to provide specific indicia for use in the universal key security methods and systems disclosed herein is a Radio Frequency Identification (“RFID”) tag. An RFID tag generally comprises a tiny integrated circuit chip that is programmed to contain particular information, whereby such information can be transmitted upon the reception of an appropriate radio frequency (“RF”) signal. One or more antennae are typically attached to the RFID tag to aid in the reception and transmission of RF signals, and the overall size of a typical RFID tag can be on the order of a flake of pepper. Use of RFID tags has been compared to the use of standard UPC bar codes and scanners, although most RFID tags can store an exponentially greater amount of information than a bar code, and do not require direct line of sight and other physical factors to be satisfied in order to be activated and read by a tag reading device emitting and receiving RF signals.

In the present invention, one or more RFID tags may be used in order to provide a source of identifying indicia with respect to the mechanical key being used. Such identifying indicia are preferably in addition to one or more other sources of indicia as discussed above. In such an RFID tag utilizing embodiment, an RFID tag can be programmed to have a set code, with such a tag to be preferably embedded within an associated mechanical key 100. An RFID tag reader can be located within or about a gaming machine of interest, such that the tag reader will emit an RF signal at least when a mechanical key is inserted into a lock of the gaming machine. If the RFID tag embedded within the mechanical key being used emits an appropriate code upon activation, and that code is then read by the tag reader, then an authorizing signal can be sent from the reader to the electromechanical lock. Preferably, the lock is designed such that it will not open unless and until it receives such an authorizing signal. Such an adaptation is useful in instances where, for example, an individual has attempted to create unauthorized copies of the mechanical key, which copies would presumably not work properly without an embedded RFID tag containing a correctly programmed code.

Similarly, an electromechanical lock utilizing any associated biometric or non-biometric sources of user specific indicia will preferably likewise not become operable until an authorizing signal is sent to the lock from whatever device or devices are measuring and analyzing such user specific indicia to confirm the presence of an authorized user. Such analyzing devices can be in the form of a smart chip or processor within the key itself, or can be in the form of separate units within the lock or located remotely from the lock. Such separate units may take the form of, for example, numeric keypads with a built in microprocessor, an analytical unit within the electromechanical lock itself, or a remote unit in communication with the lock. Such a remote unit can be part of a network, whereby a centralized general purpose server or specialized security server is utilized to regulate and monitor a variety of security items, including access to a number of gaming machines. Further discussion of such a system, as well as one means of implementing electrical communications between a mechanical key and a corresponding lock and/or system, is provided in greater detail below.

In this manner, a much higher level of control over locking systems and their respective distributed mechanical keys may be had by a managing entity, such as a casino operator. Should one or more keys become lost or stolen, such keys could presumably not be used by just anyone, despite the ability of the key to fit physically into its designated lock or locks. Because an unauthorized user would presumably not be able to satisfy an inquiry associated with the lock as to whether the user is an authorized user, simple possession of a key will typically be insufficient to grant access to the secured environment of interest. Consequently, casino establishments and other business owners would not be required to refit many machines with new locks and issue new keys whenever a problem has taken place with respect to one or more mechanical keys. The resulting time and money that will be saved in the long run by not requiring such practices is thought to be substantial.

Turning now to FIG. 5, the electrical contact region 130 of the mechanical key of FIG. 4 is illustrated in magnified side elevation view. This region of the mechanical key is at least one example of a way to provide electrical communication between the key and an electromechanical lock and/or security network. As detailed above, profiled component 110 of the key preferably comprises a metal or other hard plastic material suitable for forming typical shapes, side profiles and edge profiles in mechanical keys. Insert 131 is preferably attached to the rest of the key within a recess or other designated area of profiled component 110 that abuts the handle of the key. Such an attachment can be accomplished via a press-fit design, glue, welds, epoxy or other suitable attachment means. Atop insert 131 are one or more electrical contacts 132-135, with such one or more contacts being used to transmit power and/or one or more electrical signals to and from the key. Due to the need for multiple electrical leads within a small space, insert 131 is preferably comprised of an electrically insulating material, such as plastic, resin, quartz, or glass, for example, with at least one internal electrical wire or lead (not shown) running from each electrical contact through the insert and to an electrical contact (not shown) at the edge of the handle abutting the insert.

Electrical contacts 132-135 are arranged such that each will make contact with a designated electrical contact within the tumbler or other internal component of the electromechanical lock when the key is fully inserted into the lock. Separate leads or wires connected to each internal contact within the lock are then connected to one or more appropriate electronic distribution and/or analytical units capable of processing electrical signals sent from the key. While exactly four electrical contacts 132-135 are illustrated in the present exemplary embodiment, it will be readily appreciated that a greater or fewer number of contacts arranged in any of a variety of formations and locations can also be utilized as desired. While USB type of electrical contacts are preferable, other standard or customized types of contacts are also contemplated. In this particular embodiment, contacts 132 and 133 can be designated for data transmission from (and also possibly into) the key, while contacts 134 and 135 are “power” contacts, whereby electrical power can be input into the key to operate the fingerprint sensor and microprocessor, if applicable. Alternatively, the key can contain a battery, whereby power is transmitted from the key to the lock via the power contacts on the key. In such an instance, it may be possible for the lock to have no power source other than that provided to it by the key.

In one embodiment, the mechanical key is not powered up until it receives power via power contacts 132 and 133 from a mechanical lock into which it is inserted. At that time, an embedded fingerprint sensor reads the fingerprint of the person holding the handle of the key outside the lock, and either processes and analyzes this information itself, possibly through use of a smart chip or processor also located in the key handle, or sends fingerprint related data through data contacts 134 and 135 to be processed by the lock or remotely. If fingerprint data is processed and analyzed locally within the key handle itself, then user data authentication is said to be “non-system controlled.” In such cases, a control file having data regarding a correct fingerprint is preferably stored in one or more memory units within the key handle, such that the local smart chip or microprocessor in the key handle can readily access this control file on demand, compare data regarding the current fingerprint on the sensor, confirm whether a match has been made, and send an authorization signal to the lock via data contacts 134 and 135. Such an authorization signal can be a simple on or off signal, in which case only one data contact for sending an on or off signal might be needed, or can be somewhat encoded in pulses along one, two, or more data contacts in a manner that is readable by the lock, such that attempts to tamper or defraud the system are rendered substantially less likely to succeed.

Alternatively, the lock may comprise its own power source while the mechanical key may comprise an internal battery, such that power contacts are not needed. As another alternative, data contacts may also be eschewed in favor of a key and locking system that communicate entirely via RF signals. Such an embodiment could utilize a relatively complex RFID tag, or a smart chip or microprocessor in conjunction with an RF transceiver. Such an embodiment could include any type of Wi-Fi, Bluetooth® or other wireless communications, as discussed previously. In the instance of a mechanical key having an internal battery and utilizing RF technology for all data communications, electrical contacts may not be needed at all. In the event that analysis and authentication of a proffered fingerprint is not to be accomplished internally within the mechanical key itself, then user data authentication is said to be “system controlled.” In such cases, one or more analysis or authentication steps can take place within or around the actual electromechanical lock, or at some remote location such as over a server-based network, as described in greater detail below.

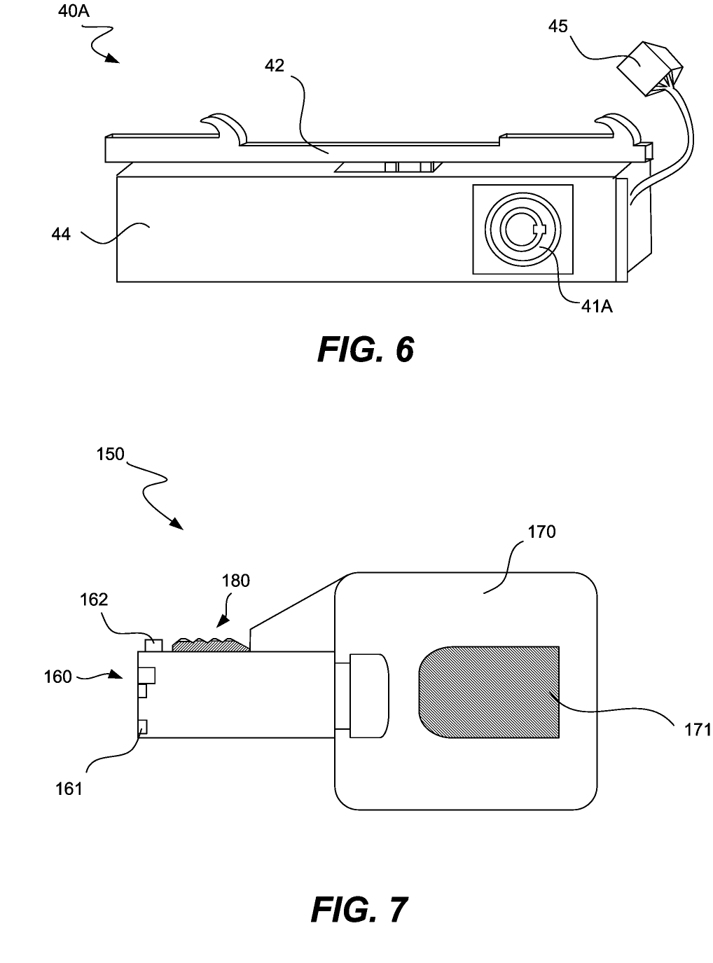

Referencing FIG. 6, an alternative exemplary electromechanical lock according to one embodiment of the present invention is illustrated in side perspective view. Electromechanical lock 40A is substantially similar to the electromechanical lock 40 of FIG. 3, except that lock 40A comprises a tubular style mechanical lock having a tubular key access 41A in addition to one or more associated locking mechanisms 42, an external housing 44 and one or more electrical connections 45. As in the foregoing example above, favorable control and movement of locking mechanism 42 is accomplished as a result of a successful operation of the lock, preferably via key access 41A through use of an authorized key by an authorized user. Similarly, an authorizing electrical signal can be sent into the lock from an outside source via connection 45, or can be generated entirely from within the lock, key access, and/or key itself, with alternative types of wireless communications such as Bluetooth and other Wi-Fi systems also being available for such communications.

Referencing corresponding FIG. 7, an alternative exemplary mechanical key having an embedded biometric device according to one embodiment of the present invention is illustrated in side elevation view. Mechanical key 150 comprises a tubular key having a profiled component 160 and a handle 170. As in the foregoing example, profiled component 160 is preferably constructed from a hard metal or plastic, such that its shape and profile will be substantially maintained over time. This profiled component 160, which is typically cylindrical and hollow, includes one or more physical features such as individual cuts or grooves 161 and/or teeth or guides 162, the combination of which can be physically “read” by a lock to determine whether or not a particular tubular key is a correct key for that lock. Similarly, key handle 170 can be constructed from the same material as the rest of the key, but is preferably made of a plastic, resin or other hardened and electrically insulating material. According to one embodiment of the present invention, handle 170 includes at least one biometric device 171, which is preferably embedded within the handle, and is preferably a fingerprint sensor, examples and functionality of which are provided above. As in the foregoing example, a fingerprint or other form of biometric data is thus one source of indicia comprising information or data specific to a particular user of key 150.

Also similar to the foregoing example, one or more electrical signals are preferably sent and/or received from key 150 as a way of communicating data and/or authorization status with respect to the fingerprint sensed at the key handle. Such electrical signals can be communicated through an electrical contact region 180 of the key, a Wi-Fi type or other wireless system or other communication means, as desired, with any such communicated data and/or authorization signal or status being preferably encrypted through any of a number of readily available encryption programs or systems. Electrical contact region 180 can be substantially similar to the electrical contact region 130 of the foregoing example, or can be modified as desired to fit the particular physical parameters of the various tubular key and lock system being used. Alternative locations for this region can be, for example, on or nearer to the lip or front end of the key, or within the hollowed out region inside profiled component 160, if applicable. Although the foregoing discussion and illustrations have been made with respect to cylinder and tubular keys and locks, it will be readily understood that other types of keys and locks can also be readily adapted for use with the inventive universal key security method and system disclosed herein, such that further examples would be cumulative and are not necessary.

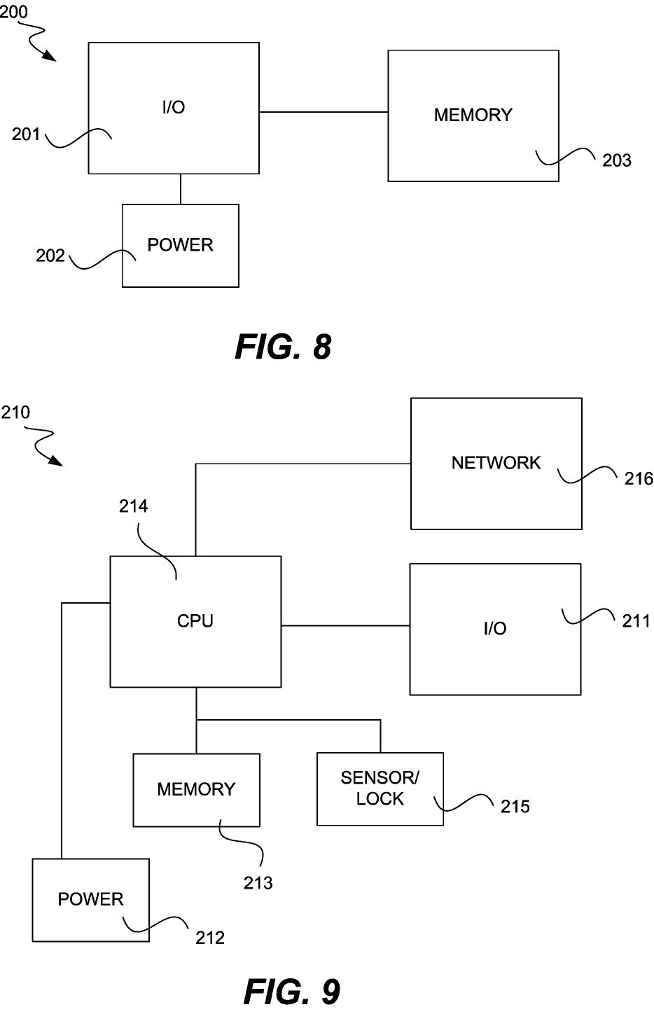

Turning now to FIGS. 8-10, several block diagrams of particular embodiments incorporating the universal key security method and system according the present invention are illustrated. As seen in FIG. 8, a non-system controlled universal key security reading system 200 comprises at least three basic components, an Input/Output (“I/O”) device 201, a power source 202 and at least one memory unit 203. In this basic system, an I/O device can comprise, for example, a fingerprint reader, a voice recognition system, a retinal scanner, a numerical keypad, or any other suitable device for reading data associated with one or more particular users. Such an I/O device 201 will typically require power, which is provided via the power source 202, which can comprise, for example, a battery embedded into the key handle, an external battery or A/C power source delivered via one or more power contacts, or in some cases a sufficient level of RF energy emitted from a remote RF powering and reading device. I/O device 201 will also typically require access one or more stored control files in at least one memory unit 203 for comparison with specific input on a user whenever an access is attempted. Such a memory unit can comprise flash memory, RAM, or any of a wide variety of memory types, but preferably comprises some form of ROM or other relatively stable memory device. As set forth previously, this non-system controlled embodiment operates to read indicia from a key user and analyze and authenticate such data entirely within the key itself, such that an authentication signal is sent from the key itself to the lock upon the confirmation of proper user-related information.

As seen in FIG. 9, an alternative system controlled universal key security reading system 210 comprises not only an I/O device 211, a power source 212 and at least one memory unit 213, but also at least three additional basic components as well. Central to this system controlled embodiment is the presence of a CPU 214, an independently controlled sensor or other device within an electromechanical lock 215, and a network 216. As detailed in the preceding system, I/O device 211 can comprise, for example, a fingerprint reader, a voice recognition system, a retinal scanner, a numerical keypad, or any other suitable device for reading data associated with one or more particular users. While such an I/O device 211 may require power, such power can be delivered from a battery (not shown) located within the I/O device itself, or alternatively via an outside power source 212 either directly or through another component, such as the CPU 214. At least one memory unit 213 is also present for comparison with specific input on a user whenever an access is attempted, although such a memory unit or units are typically to be accessed by the CPU 214, or alternatively by the network 216 in this system controlled embodiment. As in the above instance, memory unit 213 can comprise flash memory, RAM, or any of a wide variety of memory types, but preferably comprises some form of ROM or other relatively stable memory device.

In the system controlled embodiment, data is sent from I/O device 211, which can be, for example, a fingerprint sensor or numerical keypad, to the CPU 214 and/or network 216 for evaluation and/or recordation. CPU 214, which can be within the electromechanical lock itself or elsewhere within the gaming machine, or alternatively at some remote location receives data from I/O device 211 and proceeds to compare this offered data from a current user to one or more stored files within one or more memory units 213. Such a stored file can comprise, for example, a plurality of indices for a particular fingerprint of an authorized user. If a match cannot be confirmed, then no authorization signal is sent to the electromechanical lock, such that the lock is not opened. If a match is confirmed, then CPU 214 may be set to autonomously send an authorization signal to permit the lock to be opened, or may be required to confirm further information from the network 216 before doing so. Such further information may comprise data relating to whether a given user is still currently authorized within the network, or whether a given user has restricted access limited to certain machines or certain dates or times. Such further information from the network can be requested by the CPU either before, during or after it receives and analyzes data from the I/O device, although the CPU will preferably not sent an authorization signal to the lock until it obtains positive further information from the network permitting it to proceed. In addition to potentially assisting with the determination of the system on whether or not to permit the opening of the lock, network 216 is also preferably utilized for the tasks of recording and organizing specific factual details regarding one or more users, machines and/or transactions.

Assuming that a correct match of current user data is made with that which is stored within one or more files, and that network approval has been granted if necessary, then CPU 214 sends an authorization signal to an independently controlled sensor or other device within an electromechanical lock 215, such that the lock can then be opened, preferably so long as the mechanical key remains inside the lock to turn the lock physically as it opens. In this manner, the electrically controlled stop on the entire lock must be satisfied through separate mechanisms either inside the secured environment or remotely, making it significantly harder to cheat or otherwise defraud the system merely because one has the mechanical key that is adapted to physically fit within and operate the lock.

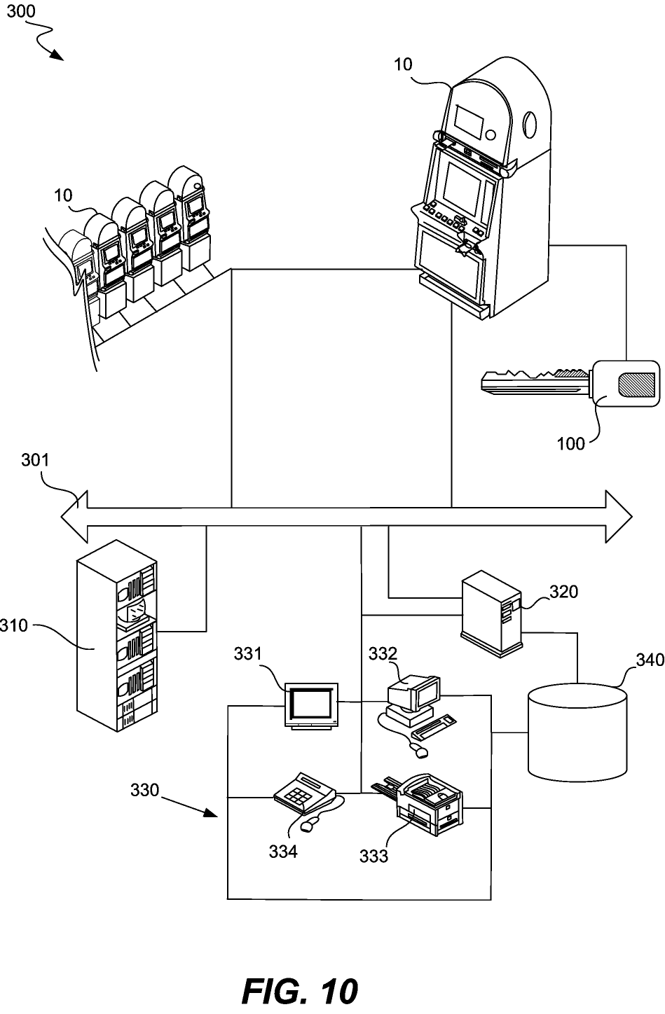

FIG. 10 illustrates a block diagram of a particular network infrastructure for providing a universal key security method and system according to one embodiment of the present invention. Network 300, which may be substantially similar to the network 216 discussed above, comprises a number of components for effectively administering the inventive universal key security methods and systems disclosed herein over a number of machines or even an entire establishment or network of establishments. One or more gaming machines 10 in a plurality of locations, either in banks or standing alone, or connected to the network via any desired operable connection means, such as by wiring to a common bus 301 that can be connected to at least one general-purpose server 310.

Such a general-purpose server 310 may be one that is already present within an establishment for one or more other purposes in lieu of or in addition to security. Other functions for such a networked general-purpose server include, for example, accounting and payroll functions, Internet and e-mail capabilities, switchboard communications, reservations and other hotel and restaurant operations, and other assorted general establishment operations. In some instances, security functions may also be associated with or performed by such a general-purpose server. For example, such a server may be linked to one or more gaming machines within an establishment, and in some cases form a network that includes all or substantially all of the machines within that establishment. Communications can then be exchanged from each machine to one or more security related programs on the general-purpose server. For example, the server may be programmed to poll each machine for affirmative security clearance on a regular basis to determine whether all is well with that machine. In addition, the server can be programmed to monitor each potential access within any of the gaming machines under its domain, such that any successful or unsuccessful attempt to access a gaming machine under the universal key security devices disclosed herein can be watched and/or recorded.

In a particularly preferred embodiment, however, network 300 also comprises at least one additional special purpose or security server 320, which is used for various functions relating to security within the security network. Such an additional security server is desirable for a variety of reasons, such as to lessen the burden on the general-purpose server or to isolate or wall off some or all security information from the general-purpose server and thereby limit the possible modes of access to such security information. In addition, security server 320 may be used as the exclusive controlling entity for any network needs with respect to any universal key security methods and systems being used by an establishment. Alternatively, network 300 can be isolated from any other network within the establishment, such that a general purpose server 310 is entirely impractical, such that a special purpose server 320 dedicated solely to universal key security measures is implemented. Under either embodiment of an isolated or shared network, universal key security server 120 also preferably includes connections to a network 330 of one or more peripheral devices, as well as a database or other suitable storage medium 340. Peripheral devices may include, but are not limited to, one or more video monitors 331, one or more user terminals 332, one or more printers 333, and one or more other digital input devices 334, such as a card reader or other security identifier, as desired.

Database 340 is preferably adapted to store many or all files related to user specific information, such that these files might be accessed directly by a requesting machine CPU, or for backup purposes. Further information as to the status of and any pertinent restrictions with respect to each past or present authorized user can also be kept within this database. In addition, this database can also be adapted to store transactional related data for each time an access to a gaming machine is even attempted. Parameters for storing such transactional related items can vary widely, and are left up to the discretion of the system administrators. Database 340 is also preferably directly accessible by one or more of the peripheral devices on network 330 connected to universal key security server 320, such that data specific to given users or transactions that are recorded on the database may be readily retrieved and reviewed at one or more of the peripheral devices. In addition, it is contemplated that one or more peripheral devices on network 330 may also be connected directly to common bus 301, as illustrated, although such an arrangement may not be desirable, depending on the level of security clearance desired within network 300.

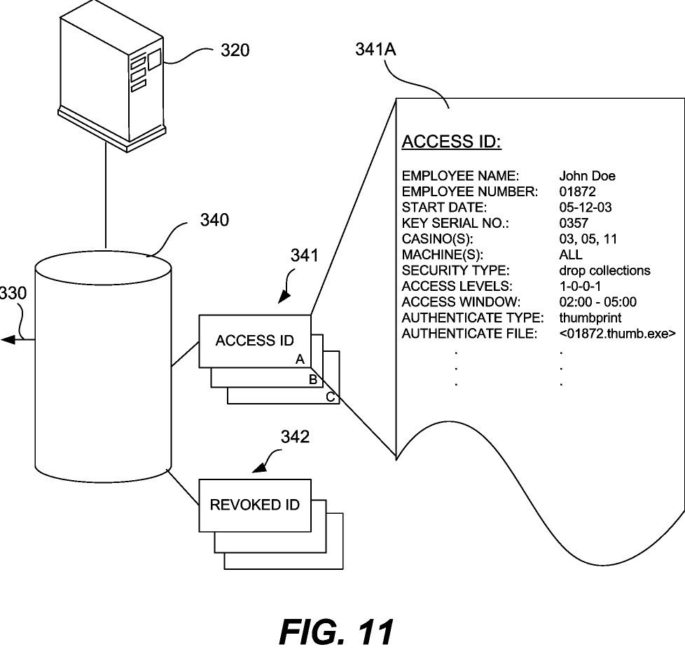

Referring now to FIG. 11, an exemplary database containing associated data identifiers of various authorized and canceled individuals according to one embodiment of the present invention is illustrated. As similarly illustrated in FIG. 10, database 340 is accessible to one or more servers, preferably at least universal key security server 320, and has a connection to a network 330 of one or more peripheral devices. Database 340 preferably contains information related to a plurality of prior machine access transactions, as well as information related to a plurality of past and present authorized users within the system. In addition, database 340 can be constructed such that it also contains files with respect to other individuals, such as biometric data files on known or suspected cheats or thieves, such that a possibly fraudulent attempt to access a gaming machine might be more readily attributable to a known non-authorized individual rather than to nobody in particular.

Contained within database 340 are numerous files with respect to many different past and present users of the system, and preferably all such users are contained within database 340 or a collection of associated databases. Such files can be classified according to presently authorized user files 341 and previous but no longer authorized user files 342. Contained within each file is a user profile having numerous informational items, restriction requirements, if any, access level or levels, and preferably at least one authentication file containing information for that user that is to be used to authenticate the user at the time that a mechanical key is used. As shown for user file 341A, such information can include items such as, for example, an employee name and number, a start date, a specific number for the mechanical key or keys issued to that employee, restriction information with respect to that employee, and one or more authentication types and files, among others. Restriction information can include the casinos, floors or locations to which that employee is authorized, the machine types, machine denominations, machine numbers, security types, levels of access within each machine, temporal restrictions with respect to time and dates that machines are accessible by that employee, and other such information. Such information can not only be stored within a user file within the database, but can also be retrieved and utilized by the universal key security server 320 and/or a CPU within a gaming machine into which access is being attempted in order to determine whether an otherwise authenticated user is authorized for access at the particular location, machine, level within the machine, date and time that access is being attempted.

As discussed previously, each secured key accessible environment, such as a gaming machine, can have separate levels of security within the machine, with a separate authorization status required for each level for each system user. For example, a particular gaming machine may have different access levels for: I) its main door, II) its primary CPU, III) its bill acceptor, and IV) its coin drop. Although additional internal items can require access such that additional levels can be added, only the four listed levels will be discussed herein for purposes of brevity and clarity. Whether a user has access to one of these four levels is preferably independent of whether that same user has access to another, unless of course main door access or a similar broader level of access is required for an otherwise authorized access to an internal component requiring an open main door or access to the broader level.

In this example, the access levels for a particular user can be designated as I-II-III-IV, with a “1” or “Y” for yes and a “0” or “N” for no depending on whether or not a user is authorized for each given level. For instance, Sam the mechanic is only authorized to open the main door of the gaming machine, and nothing else. Hence, the user file 341 for Sam will contain an “Access Levels” designation of 1-0-0-0. Similarly, Joe the technician is permitted access to the main door and to the CPU region of the gaming machine, such that the Access Level designation for Joe will read 1-1-0-0. Continuing further, Bill the drop collector has an Access Level designation of 1-0-1-1, while the designation for Ted the administrator is 1-1-1-1. Of course, more levels can be added and designated for each user, and the Access Level designations for each user can be altered over time, or set to 0-0-0-0 in some cases.

In the event that an authorized user is demoted, discharged or otherwise loses some or all of the access privileges previously granted to that user, then such a user file can be appropriately updated by a system administrator, or alternatively reclassified as a file for a user that is no longer authorized in any capacity. In such cases, user information and biometric files can be maintained within a database in order to possibly utilize such information in the future in the event that unauthorized access may be attempted at some point. In addition, it may be critical for some systems to rely on such input from the security server on the network, rather than on isolated and localized files within individual keys or machines, since status updates as to potential “de-authorizations” on such localized files would tend to be nonexistent or more sporadic than updates on the main network and server. While one example of a database for storing such valid user and banned or revoked user files could be a proprietary database designed for the specific association and use with the inventive key security method and system disclosed herein, other databases can be utilized for this purpose as well. Such other databases can include, for example, other proprietary databases associated with other functions within the casino or establishment, private databases from other entities that may or may not require subscriptions for access and use, and databases shared with various government or regulatory agencies.

According to one embodiment of the present invention, a provided apparatus or system, and preferably a network or like structure, is adapted to record data or information related to an attempted access of a gaming machine or device as the transaction occurs. Such live data capture can be used immediately in the event that an alarm needs to be triggered, and can also be stored indefinitely in one or more databases, such as the database described above. In the event that one or more alarms are to be triggered in conjunction with use of the present universal key security system, it is preferable that this system be at least somewhat intertwined with one or more elements of a greater security system and network within an establishment or casino, such that any fumbling of keys, mis-punching of keypad buttons, improper alignment or insufficient exposure of a finger or thumb with respect to a fingerprint sensor or any other common human error does not automatically trigger an alarm and/or armed response.

Intertwined use with an existing security system can include the use of, for example, alarms and one or more security cameras and/or microphones, with such cameras and microphones being possibly controlled from a control room or area, whereby a first alarm merely signals an operator or automated computer response to focus at least one camera on the affected machine to monitor and/or record the potentially problematic transaction. Live data capture can be used for other purposes as well, many of which involve the storing of such information for use at a later time, such as, for example, in the event of a power outage or other machine shutdown, to provide specific evidence corroborating the version of the casino operator as to how a certain transaction took place, or to track a pattern of use or misuse with respect to one or more machines or users.

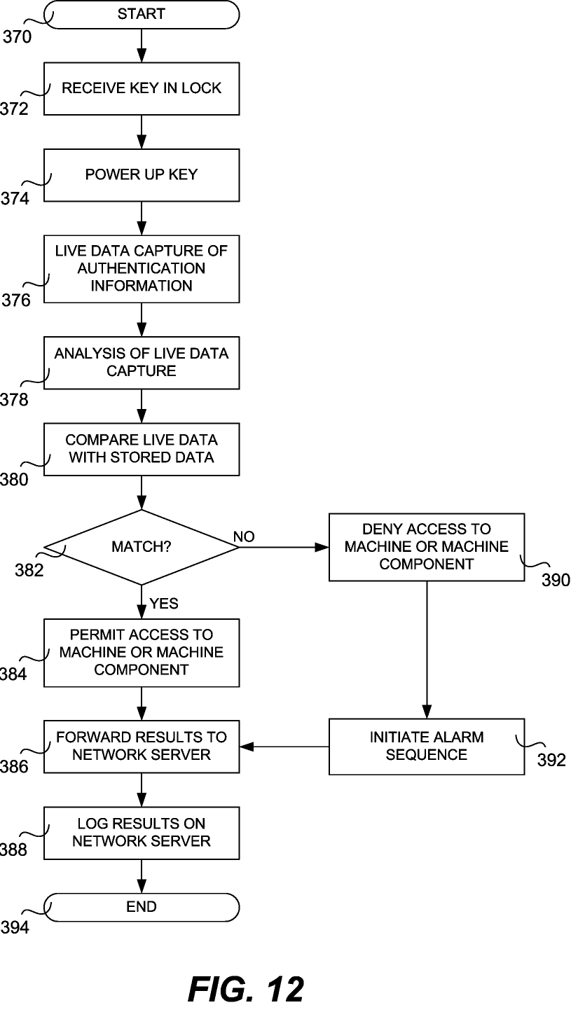

Turning now to FIG. 12, a flowchart outlining one method of providing a universal key security method and system according to one embodiment of the present invention is illustrated. After a start step 370, a first step 372 of receiving a key into a lock initiates the process, upon which a subsequent step 374 of providing power to or otherwise enabling the mechanical key takes place. In the event that biometric or other data is provided at a location other than the mechanical key itself, then such other provision of user specific data is also “powered up” or similarly initiated at step 374. At a following step 376, the live data capture of authentication information and possibly other information related to a particular access transaction takes place. Live data that can be captured in addition to any user specific stored files and present live authenticating information can include, for example, the specific machine and its location, the date and time of the access transaction, the length of the access, the different levels accessed within the machine, and the presence of more than one authorized individual at or near the machine, among others. Such live data capture is preferably accomplished through the transmission of data, with the actual transmission involving the encryption of data according to one or more encryption programs or systems.

Once a sufficient amount of live data has been collected from a key user, with such data being fingerprint data, other biometric data, or a PIN entry, for example, then the method proceeds to step 378, where the live data captured can be analyzed. This is accomplished by a CPU or other similar processor either within the key, the lock, the gaming machine or remotely over a network. Once the captured or collected live data is analyzed, it is compared at a step 380 to data in a control file that is stored in one or more memory locations, as described in greater detail above. After such a comparison is made, an inquiry as to whether a match exists between the live captured data and the data on file is then made at a decision step 382. In the event that a match is indeed made, the process continues to a step 384, wherein the lock is opened and access to the machine or internal machine component is permitted. During or after this access, results and data are then forwarded to a universal key security server on the network at a subsequent step 386, whereupon the server may decide to discard some or all of the results and data, or store some or all of it on an associated database at a subsequent result logging step 388, whereupon the method reaches an end stage 394. Again, any transmission or communication of data, results, commands or other information is preferably accomplished through the use of one or more encryption programs or systems.

In the event that a match is not had in response to the inquiry made at decision step 382, however, then the process continues to a step 390, wherein physical access is denied to the overall gaming machine or internal component of interest contained therein. At a following step 392, an alarm sequence is then initiated, whereby a full alarm and response can be sounded, or a notice provided to other security personnel or systems that more attention is needed at the concerned gaming machine or device. After alarm sequence step 392, the process then rejoins the main process branch at informational forwarding step 386, where again the network server may decide to discard some or all of the results and data, or store some or all of it on an associated database at a subsequent result logging step 388, whereupon the method reaches an end stage 394. As in the foregoing process steps, any transmission or communication of data, results, commands or other information is preferably accomplished through the use of one or more encryption programs or systems.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

1. A method of providing security in a gaming machine, the method comprising:
receiving a mechanical key in a lock within said gaming machine;
reading a first source of indicia from said key,
wherein said first source of indicia comprises information or data specific to said lock;
reading a second source of indicia, wherein said second source of indicia comprises information specific to one or more users of said key;
authorizing a use of said key based on the readings of said first and second sources of indicia; and
permitting access to said key accessible environment.

2. The method of claim 1, wherein said first source of indicia comprises one or more physical characteristics of said key.

3. The method of claim 2, wherein said one or more physical characteristics of said key comprises at least one item selected from the group comprising a physical shape of said key, a groove arrangement of said key, and at least a portion of an edge profile of said key.

4. The method of claim 1, further including the step of:
capturing live data reflective of one or more parameters associated with any other step.

5. The method of claim 1, wherein said information specific to one or more users of said key comprises biometric information with respect to said one or more users.

6. The method of claim 5, wherein said biometric information comprises fingerprint related information.

7. The method of claim 5, wherein said biometric information comprises at least one item selected from the group consisting of facial recognition, voice recognition, and retinal scan.

8. The method of claim 1, wherein said information specific to one or more users of said key is contained within one or more authorized user IDs.

9. The method of claim 8, further including the step of:
revoking a previously authorized user ID.

10. The method of claim 1, further including the step of:
restricting access to said key accessible environment selectively based on one or more additional factors.

11. A method of providing security in a key accessible environment, the method comprising:
receiving a key in a lock;
reading a first source of indicia from said key,
wherein said first source of indicia comprises information or data specific to said lock;
reading a second source of indicia, wherein said second source of indicia comprises information specific to one or more users of said key;
authorizing a use of said key based on the readings of said first and second sources of indicia; and
permitting access to said key accessible environment.

12. The method of claim 11, wherein said first source of indicia comprises one or more physical characteristics of said key.

13. The method of claim 12, wherein said one or more physical characteristics of said key comprises at least one item selected from the group comprising a physical shape of said key, a groove arrangement of said key, and at least a portion of an edge profile of said key.

14. The method of claim 11, further including the step of:
capturing live data reflective of one or more parameters associated with any other step.

15. The method of claim 11, wherein said information specific to one or more users of said key comprises biometric information with respect to said one or more users.

16. The method of claim 15, wherein said biometric information comprises fingerprint related information.

17. The method of claim 15, wherein said biometric information comprises at least one item selected from the group consisting of facial recognition, voice recognition, and retinal scan.

18. The method of claim 11, wherein said information specific to one or more users of said key is contained within one or more authorized user IDs.

19. The method of claim 18, further including the step of:
revoking a previously authorized user ID.

20. The method of claim 11, wherein said information specific to one or more users of said key involves the use of an active PIN authentication.

21. The method of claim 11, further including the step of:
restricting access to said key accessible environment based on one or more additional factors.

22. The method of claim 21, wherein one additional factor includes the use of specified time periods.

23. The method of claim 11, wherein said key accessible environment comprises a gaming machine.

24. An apparatus, comprising:
a key accessible environment; and
an electromechanical lock securing said key accessible environment, wherein said electromechanical lock is adapted to deny access to said key accessible environment unless a mechanical key having a correct first source of indicia is inserted into the lock and an authorization signal is provided based upon the verification of a correct second source of indicia with respect to the user of said mechanical key.

25. The apparatus of claim 24, wherein said first source of indicia comprises at least one item selected from the group comprising a physical shape of said key, a groove arrangement of said key, and at least a portion of an edge profile of said key.

26. The apparatus of claim 24, wherein said second source of indicia comprises biometric information with respect to said user of said mechanical key.

27. The apparatus of claim 26, wherein said biometric information comprises fingerprint related information.

28. The apparatus of claim 24, wherein second source of indicia involves the use of an active PIN authentication.

29. An apparatus, comprising:
a locking means for securing a key accessible environment, wherein said locking means is adapted to deny access to said key accessible environment unless two separate sources of indicia are read and confirmed by said locking means.

30. The apparatus of claim 29, further including an opening means for unlocking said locking means, said opening means having a first source of indicia comprising information or data specific to said locking means and a second source of indicia comprising information specific to one or more users of said opening means.

31. A gaming machine, comprising:
at least one key accessible region; and
an electromechanical lock securing said at least one key accessible region, wherein said electromechanical lock is adapted to deny access to said key accessible region unless a mechanical key having a correct first source of indicia is inserted into the lock and an authorization signal is provided based upon the verification of a correct second source of indicia with respect to the user of said mechanical key.

32. The gaming machine of claim 31, wherein said first source of indicia comprises at least one item selected from the group comprising a physical shape of said key, a groove arrangement of said key, and at least a portion of an edge profile of said key.

33. The gaming machine of claim 31, wherein said second source of indicia comprises biometric information with respect to said user of said mechanical key.

34. The gaming machine of claim 33, wherein said biometric information comprises fingerprint related information.

35. The gaming machine of claim 31, wherein second source of indicia involves the use of an active PIN authentication.

36. A method of providing security in a gaming machine, the method comprising:
receiving a key in a lock;
reading a user-based source of indicia, wherein said user-based source of indicia comprises information specific to one or more users of said key;
authorizing a use of said key based on an affirmative reading of said user-based source of indicia; and
permitting access to said gaming machine or a component thereof in the event that said key is a correct key for said lock.

37. The method of claim 36, further including the step of:
capturing live data reflective of one or more parameters associated with any other step.

38. The method of claim 36, wherein said information specific to one or more users of said key comprises biometric information specific to said one or more users.

39. The method of claim 38, wherein said biometric information comprises fingerprint related information.

40. The method of claim 38, wherein said biometric information comprises at least one type of information selected from the group consisting of fingerprint, facial recognition, voice recognition, and retinal scan information.

41. A universal key security system, comprising:
at least one computer server; and
one or more gaming machines in communication with said at least one computer server, wherein at least one of said one or more gaming machines comprises an electromechanical lock securing at least one region of said gaming machine,
wherein said electromechanical lock is adapted to deny access to said at least one region of said gaming machine unless a key having a correct first source of indicia is inserted into the lock and an authorization signal is provided based at least in part upon the verification of a correct second source of indicia with respect to the user of said mechanical key.

42. The universal key security system of claim 41,
wherein said information specific to one or more users of said key comprises biometric information with respect to said one or more users.

43. The universal key security system of claim 41, further including a database in communication with said at least one computer server.

44. The universal key security system of claim 43,
wherein said database comprises at least one file containing information related to an authorized user of said universal key security system.

45. The universal key security system of claim 41,
wherein said at least one computer server is adapted to capture live data associated with an attempt to access said at least one region of said gaming machine secured by said electromechanical lock.

46. The universal key security system of claim 41,
wherein said authorization signal is provided at least in part through the use of said at least one computer server.

47. The universal key security system of claim 41,
wherein said verification of a correct second source of indicia with respect to the user of said mechanical key is accomplished at least in part through use of said at least one computer server.
